(19) United States
(12) Patent Application Publication
(10) Pub. No.: US 2014/0205374 A1
(43) Pub. Date: Jul. 24, 2014

(54) Torque Limiting Tolerance Ring

(71) Applicant: Saint-Gobain Performance Plastics Rencol Limited, Coventry (GB)

(72) Inventors: Benjamin Nias, Bristol (GB); Stephen Jefferies, Bristol (GB)

(73) Assignee: Saint-Gobain Performance Plastics Rencol Limited, Coventry (GB)

(21) Appl. No.: 14/160,705

(22) Filed: Jan. 22, 2014

Related U.S. Application Data
(60) Provisional application No. 61/755,925, filed on Jan. 23, 2013.

(51) Int. Cl. F16D 9/06

(52) U.S. Cl. CPC F16D 9/06
USPC 403/367

(57) ABSTRACT

A torque limiting tolerance ring is disclosed and can include a generally cylindrical body having a sidewall. The sidewall can include an unformed section. A plurality of projections can extend from the unformed section of the sidewall and the plurality of projections can be arranged in a first circumferential row and a second circumferential row. The torque limiting tolerance ring can include a frangible portion that can extend circumferentially around the tolerance ring between the first and second rows of projections.

### CROSS-REFERENCE TO RELATED APPLICATION

The present application claims priority from U.S. Provisional Patent Application No. 61/755,925, filed Jan. 23, 2013, entitled “TORQUE LIMITING TOLERANCE RING”, naming as inventors Benjamin Nias and Stephen Jefferies, which application is incorporated by reference herein in its entirety.

### FIELD OF THE DISCLOSURE

The present disclosure is directed generally to tolerance rings, and particularly to torque limiting tolerance rings.

### DESCRIPTION OF THE RELATED ART

The present disclosure relates to tolerance ring assemblies, wherein a tolerance ring provides an interference fit between parts of an assembly, in which a first part has a cylindrical portion located in a cylindrical bore of a second part. In particular, the present disclosure relates to assemblies having a tolerance ring that provides an interference fit between a cylindrical component such as a shaft and an outer component installed around the shaft.

Improved engineering techniques have resulted in the need for greater accuracy of machine parts, raising manufacturing costs. Very close tolerances are required where press fits, splines, pins or keyways are employed to transmit torque in applications such as pulleys, flywheels or driveshafts.

Tolerance rings may be used to provide an interference fit between parts required to transmit torque. Tolerance rings provide a low cost means of providing an interference fit between parts that may not be machined to exact dimensions. Tolerance rings have a number of other potential advantages, such as compensating for different linear coefficients of expansion between the parts, allowing rapid apparatus assembly, and durability.

A tolerance ring generally comprises a strip of resilient material, for example a metal such as spring steel, the ends of which are brought together to form a ring. A band of protrusions, or projections, can extend radially outwards from the ring, or radially inwards towards the center of the ring. Usually, the protrusions are formations, possibly regular formations, such as corrugations, ridges or waves.

When the ring is located within an annular space between, for example, a shaft and a bore in an outer component installed on the shaft, the protrusions are compressed. Each protrusion can act as a spring and can exert a radial force against the shaft and the surface of the bore, providing an interference fit between the shaft and the housing. Rotation of the housing or the shaft will produce similar rotation in the other of the shaft or the housing, as torque is transmitted by the tolerance ring. Typically, the band of protrusions is axially flanked by annular regions of the ring that have no formations (known in the art as “unformed regions” of the tolerance ring).

Although tolerance rings usually comprise a strip of resilient material that is curved to allow the easy formation of a ring by overlapping the ends of the strip, a tolerance ring may also be manufactured as an annular band. The term “tolerance ring” as used hereafter includes both types of tolerance ring. The term “shaft” as used hereafter includes any assembly component with a cylindrical portion, such as a shaft or a bearing.

Accordingly, the industry continues to need improvements in tolerance rings, particularly in tolerance rings that can be used to couple two rotating shafts.

### BRIEF DESCRIPTION OF THE DRAWINGS

The present disclosure can be better understood, and its numerous features and advantages made apparent to those skilled in the art by referencing the accompanying drawings.

FIG. 1 includes an end plan view of a torque limiting tolerance ring in accordance with an embodiment.

FIG. 2 includes a side plan view of the torque limiting tolerance ring in accordance with an embodiment.

FIG. 3 includes an end plan view of a rotating assembly in accordance with an embodiment.

FIG. 4 includes a side plan view of the rotating assembly in a first configuration in accordance with an embodiment.

FIG. 5 includes a side plan view of two adjacent shafts in accordance with an embodiment.

FIG. 6 includes a side plan view of a torque limiting tolerance ring installed on the two adjacent shafts in accordance with an embodiment.

FIG. 7 includes a side plan view of the rotating assembly in a second configuration in accordance with an embodiment.

FIG. 8 includes a detailed view of the rotating assembly taken at Circle 8 in FIG. 7 in accordance with an embodiment.

The use of the same reference symbols in different drawings indicates similar or identical items.

### DETAILED DESCRIPTION

The following description is directed to tolerance rings, and particularly, to torque limiting tolerance rings that can be installed between a shaft and a bore, such as within an air conditioner compressor assembly between a compressor shaft and a bore formed in a compressor pulley. In one aspect, a tolerance ring can be fitted around the compressor shaft and then, the compressor pulley can be installed around the torque limiting tolerance ring. Alternatively, the torque limiting tolerance ring can be inserted into the bore formed in the pulley and the compressor shaft can be inserted through the torque limiting tolerance ring.

In a typical tolerance ring, the tolerance ring can provide an interference fit between an inner and an outer component. As such, the inner and outer components can be statically coupled and can rotate together. If a torque between the inner and outer component becomes greater than the force of the interference fit, the inner and outer components can rotate with respect to each other. When the torque between the inner and outer components falls below the force of the interference fit, the two parts can re-engage each other. In the case in which the inner component is a shaft and the shaft seizes, e.g., due to a bearing failure, the outer component can continue to rotate on the shaft. As the outer component continues to rotate, the friction between the outer component and the tolerance ring, or between the shaft and the tolerance ring, can generate high heat. Continued movement can lead to permanent damage to the shaft, the outer component, the tolerance ring, any other nearby equipment, or all of the components.

A torque limiting tolerance ring according to one or more of the embodiments described herein can include two circumferential rows of projections and a frangible portion between the rows. The torque limiting tolerance ring can be installed over the ends of two adjacent, collinear shafts such that the frangible portion spans a gap established between the ends of the shafts. A first collar can be installed around the first row of projections and can compress the projections in order to provide an interference fit between the first collar, the torque limiting tolerance ring, and the first of the two shafts.

A second collar can be installed round the second row of projections and can compress the projections in order to establish an interference fit between the second collar, the torque limiting tolerance ring, and the second of the two shafts. Once the assembly is assembled as described, the first shaft can be coupled to the second shaft and the shafts can rotate with each other. However, if a torque between the shafts exceeds a threshold, the frangible portion of the torque limiting tolerance ring can fracture or break and the first shaft can be disconnected, or decoupled, from the second shaft. The two shafts can then rotate freely with respect to each other without generating heat. As such, the risk of further damage to the assembly can be substantially reduced.

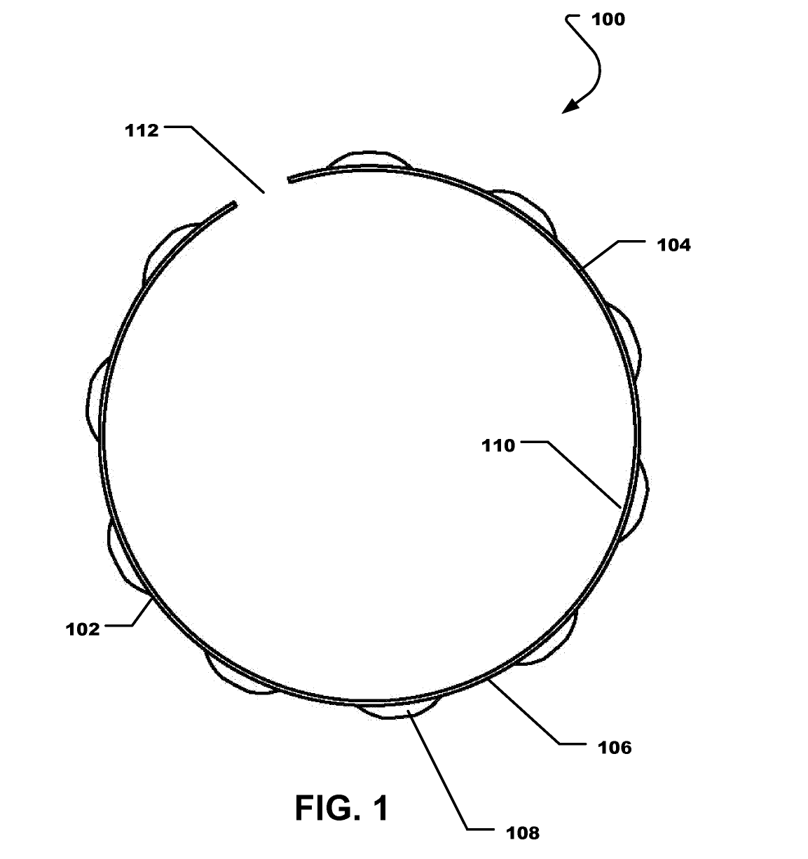

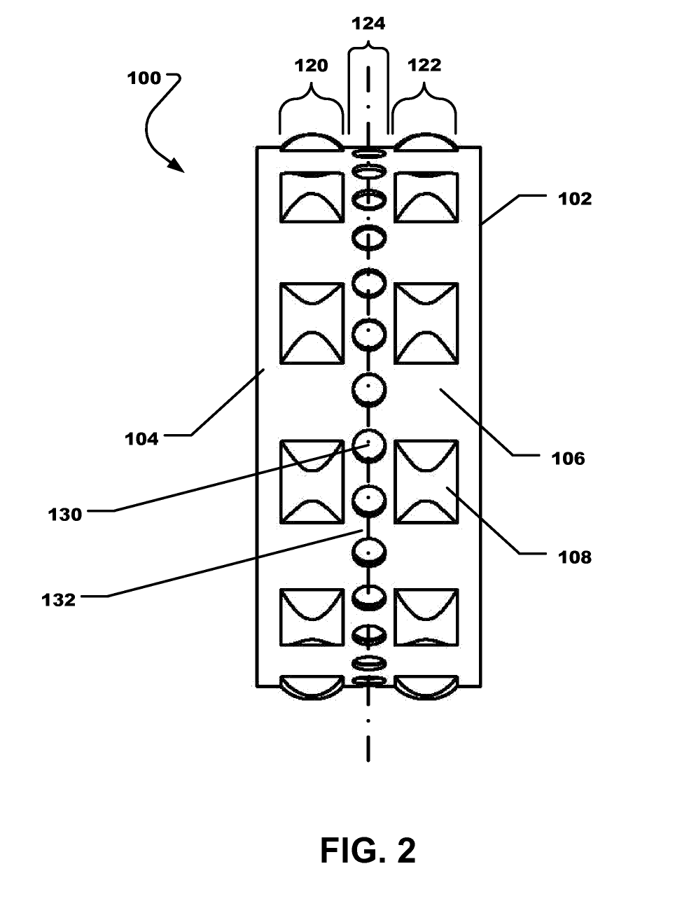

Referring initially to FIG. 1 and FIG. 2, a torque limiting tolerance ring is shown and is generally designated 100. As illustrated, the torque limiting tolerance ring 100 can include a generally cylindrical body 102. The body 102 can include a sidewall 104. The sidewall 104 can include an unformed section 106 and a plurality of projections 108 can extend radially outwardly from the sidewall 104 of the body 102. In another aspect, the projections 108 can extend radially inwardly from the sidewall 104 of the body 102. In yet another aspect, some of the projections 108 can extend radially outwardly from the sidewall 104 of the body 102 and some of the projections 108 can extend radially inwardly from the sidewall 104 of the body 102.

As illustrated, with radially outward directed projections 108, the sidewall 104 of the body 102 can include a generally cylindrical inner surface 110 free from projections. With radially inwardly directed projections (not illustrated), the sidewall 104 of the body 102 can include a generally cylindrical outer surface free from projections. The sidewall 104 can also include a gap 112 in the unformed section 106. In a particular aspect, the gap 112 can extend along a majority of the axial length of the body 102 to establish at least a partial split in the body 102. In another aspect, the gap 112 can extend along the entire axial length of the body 102 to establish a complete split in the body 102.

As best illustrated in FIG. 2, in a particular aspect, the projections 108 on the torque limiting tolerance ring 100 can be arranged to form a first circumferential row of projections 120 and a second circumferential row of projections 122. The sidewall 104 of the body 102 can include a frangible portion 124 located between the first and second rows of projections 120 and 122. The frangible portion 124 can be aligned with a central axis, or mid-line, of the torque limiting tolerance ring 100. In another aspect, all, or a portion of, the frangible portion 124 may be spaced, or otherwise distanced, from the central axis.

In a particular aspect, the frangible portion 124 can include a plurality of perforations 130 formed around the circumference of the frangible portion 124. Each adjacent pair of perforation 130 can be is separated by a frangible sidewall 132.

In a particular aspect, the perforations 130 can be equally spaced around the circumference of the frangible portion 124. The perforations 130 can also be irregularly, or unevenly, spaced around the circumference of the frangible portion 124. Further, in particular embodiments, each perforation 130 can be substantially identical to the other perforations 130. However, in other embodiments, the perforations 130 can have different sizes and shapes. In another aspect, each perforation 130 can include a circumferential length, L_{P}, and each frangible sidewall 132 can include a circumferential length, L_{FS}, and L_{P} can be ≦1000% L_{FS}, such as ≦750% L_{FS}, ≦500% L_{FS}, ≦250% L_{FS}, or ≦100% L_{FS}. Moreover, L_{P} can be ≧10% L_{FS}, such as ≧15% L_{FS}, ≧20% L_{FS}, or ≧25% L_{FS}. In another aspect, L_{P} can be with a range between and including any of the maximum or minimum value of L_{P} described herein.

In another aspect, each perforation 130 can be generally circular. Moreover, each perforation 130 can be generally ovular. In another aspect, each perforation 130 can be generally slot shaped. In yet a further aspect, each perforation 130 can be generally polygonal, such as rectangular, generally diamond shaped, or generally triangular.

In still another aspect, each frangible sidewall 132 of the frangible portion 124 of the torque limiting tolerance ring 100 can include a wall thickness, T_{FS}, the unformed portion of the sidewall can include a wall thickness, T_{UP}, and T_{FS} can be <T_{UP}. In this aspect, T_{FS} can be ≦75% T_{UP}, such as ≦70% T_{UP}, ≦65% T_{UP}, or ≦60% T_{UP}. Further, T_{FS} can be ≧5% T_{UP}, such as ≧10% T_{UP}, ≧15% T_{UP}, or ≧20% T_{UP}. Moreover, T_{FS} can be within a range between and including any of the maximum or minimum values of T_{FS} described herein.

In yet another aspect, the frangible sidewall 132 of the frangible portion 124 of the torque limiting tolerance ring 100 can include a brittleness, B_{FS}, the unformed portion of the sidewall can include a brittleness, B_{UP}, and B_{UP} can be <B_{FS}. For example, B_{UP} can be ≦75% B_{FS}, such as ≦70% B_{FS}, ≦65% B_{FS}, or ≦60% B_{FS}. Moreover, B_{UP} can be ≧5% B_{FS}, such as ≧10% B_{FS}, >15% B_{FS}, or ≧20% B_{FS}. B_{UP} can also be within a range between and including any of the maximum or minimum values of B_{UP} described herein.

The frangible sidewall 132 can be treated to increase B_{FS}. For example, the frangible sidewall 132 can be mechanically treated. Further, the frangible sidewall 132 can be drawn or stretched. In another aspect, the frangible sidewall 132 can be locally heated and quenched. Moreover, the frangible sidewall 132 can be chemically treated. For example, the frangible sidewall 132 can be etched.

In another aspect, the body 102 of the torque limiting tolerance ring 100 can include a torsional strength, T_{SF}, measured circumferentially through the frangible portion; a torsional strength, T_{SP}, measured circumferentially through the projections; and T_{SF} can be <T_{SP}. For example, T_{SF} can be ≦50% T_{SP}, such as ≦45% T_{SP}, ≦40% T_{SP}, or ≦35% T_{SP}. Moreover, T_{SF} can be ≧1% T_{SP}, such as ≧5% T_{SP}, ≧10% T_{SP}, or ≧20% T_{SP}. T_{SF} can be within a range between and including any of the values of T_{SF} described herein.

Further, the frangible portion 124 can fracture if an operating torque, T_{O}, exceeds a threshold torque, T_{T}. The torque limiting tolerance ring can include a slip torque, T_{S}, above which the projections can move slip relative to an inner wall of a bore. In such an aspect, T_{T} can be ≦90% T_{S}, such as ≦85% T_{S}, or ≦80% T_{S}. Further, T_{T} can be ≧20% T_{S}, such as ≧25% T_{S}, or ≧30% T_{S}. T_{T} can be within a range between and including any of the maximum and minimum values of T_{T} described herein.

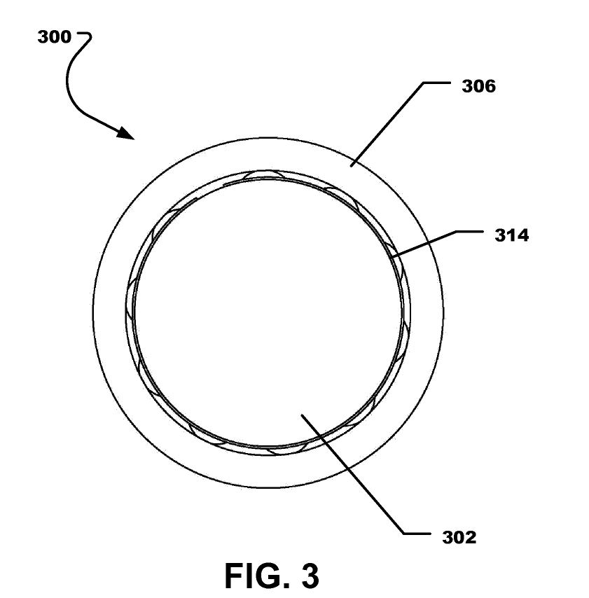

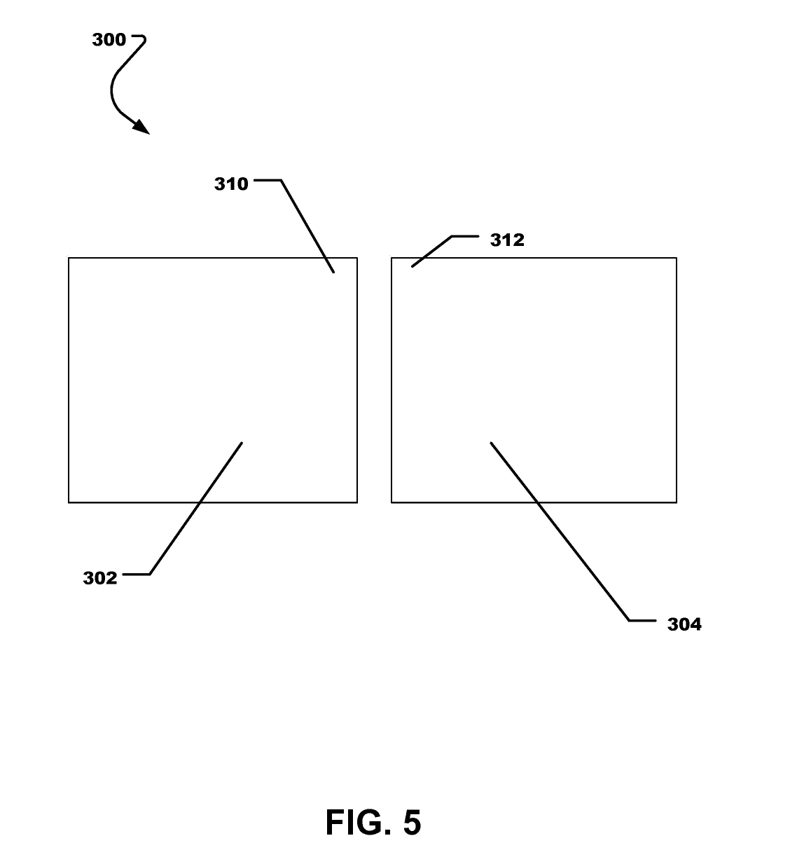

Referring now to FIG. 3 through FIG. 8, a rotating assembly is shown and is generally designated 300. The rotating assembly 300 can include a first inner component 302 and a second inner component 304. Further, the rotating assembly 300 can include a first outer component 306 and a second outer component 308. The first inner component 302 can include an end 310 and the second inner component 304 can include an end 312 and the ends 310, 312 can be spaced a distance apart from each other. In another aspect, the ends 310, 312 of the inner components 302, 304 can be touching. In yet another aspect, one end can be formed with a bore and the other end can have a reduced diameter and can fit into the bore. In each aspect, a slip interface can be formed between the ends 310, 312 of the inner components 302, 304 so that the inner components 302, 304 can move relative to each other during a torque overload condition, described in greater detail below.

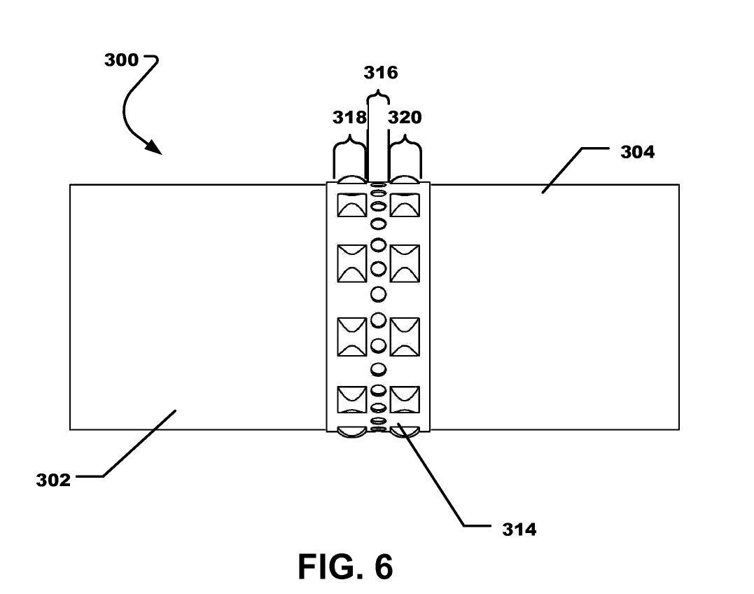

As best indicated in FIG. 6, a torque limiting tolerance ring 314 can be installed over the ends 310, 312 of the inner components 302, 304 and can span the distance between the ends 310, 312 or the slip interface established between the ends 310, 312. In a particular aspect, the torque limiting tolerance ring 314 can be the torque limiting tolerance ring 100 described in conjunct with FIG. 1 and FIG. 2.

As illustrated, the torque limiting tolerance ring 314 can be installed on the inner components 302, 304 so that that a frangible portion 316 of the torque limiting tolerance ring 314 is aligned with the space, or interface, between the ends 310, 312 of the inner components 302, 304. In another aspect, the frangible portion 316 may not be aligned with the space, or interface between the ends 310, 312 of the inner components. The frangible portion 316 may be adjacent to, or near, the interface. Further, the frangible portion 316 may be distanced from the interface.

The first outer component 306 can be installed around a first row of projections 318 on the torque limiting tolerance ring 314 so that the torque limiting tolerance ring 314 is sandwiched, or compressed, between the first inner component 302 and the first outer component 306. The second outer component 308 can be installed around a second row of projections 320 on the torque limiting tolerance ring 314 so that the torque limiting tolerance ring 314 is sandwiched, or compressed, between the second inner component 304 and the second outer component 308.

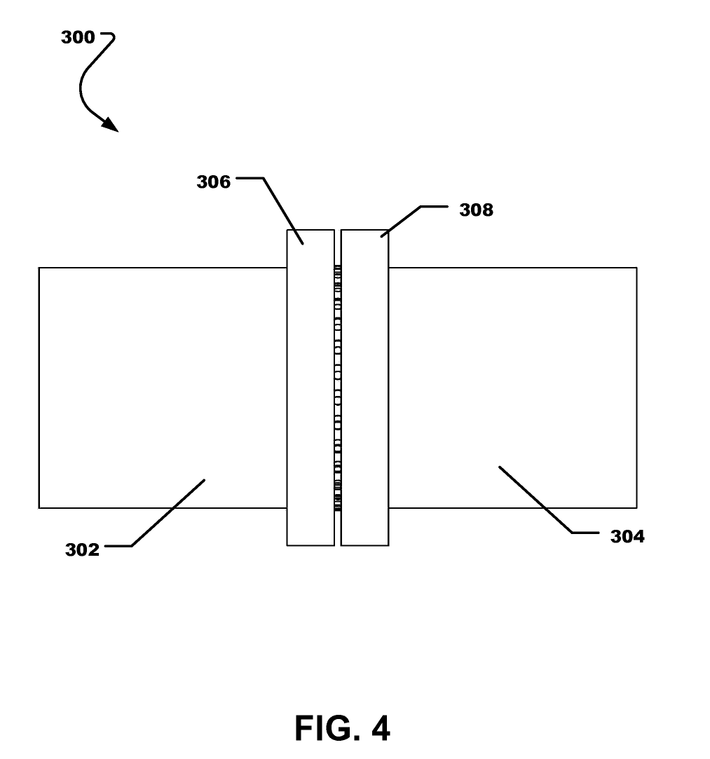

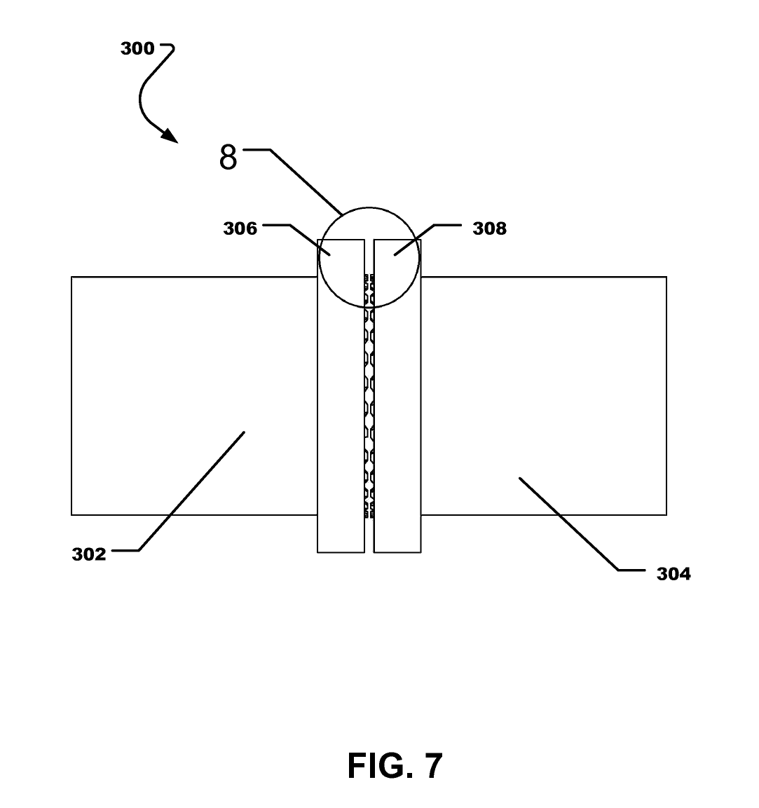

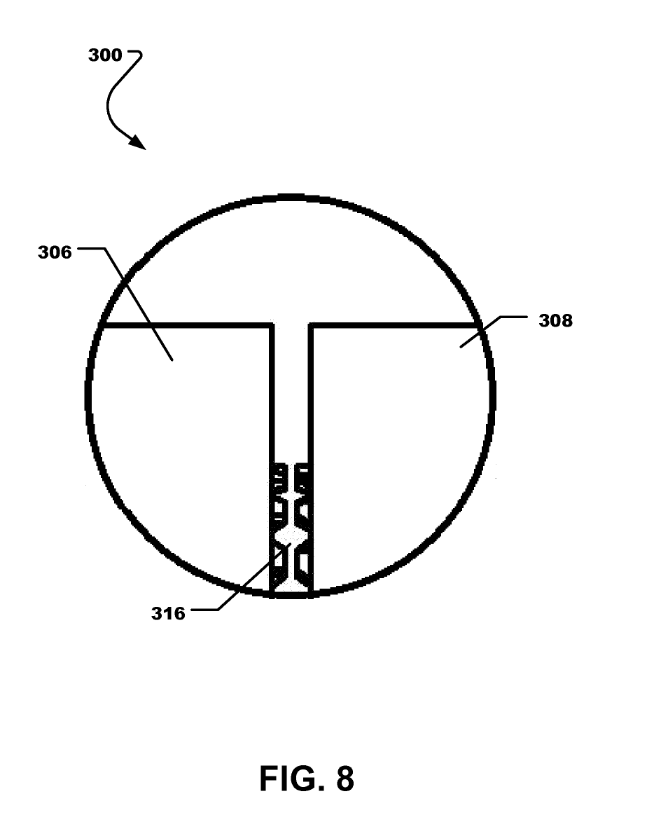

During use, the torque limiting tolerance ring 314 can move from a first configuration, illustrated in FIG. 4, in which the frangible portion 316 is intact and the first inner component 302 is statically coupled to the second inner component 304 and rotates therewith and a second configuration, illustrated in FIG. 7 and FIG. 8, in which the frangible portion 316 is completely fractured and the first and second inner components are decoupled and can rotate freely with respect to each other.

In a particular aspect, the rotating assembly 300 can be an air conditioner compressor assembly, e.g., a belt driven air conditioner compressor assembly for a motor vehicle. Further, in this particular aspect, the first inner component 302 can be a first compressor shaft and the second inner component 304 can be a second compressor shaft extending from an air conditioner compressor. The first outer component 306 can be a first collar (or pulley) and the second outer component 308 can be a second collar (or compressor pulley) installed around a respective compressor shaft. A drive belt (not shown) can extend at least partially around the outer circumference of the compressor pulley.

As the belt moves, the compressor pulley can rotate. In the engaged configuration, with the first compressor shaft statically coupled to the second compressor shaft and to the compressor pulley, both compressor shafts can also rotate. In the event of a failure within the air compressor, e.g., a bearing seizure, the first or second compressor shaft can seize within the air compressor and stop rotating. If either shaft seizes, a torque within the compressor shaft/compressor pulley assembly can exceed a threshold torque and the frangible portion 316 of the torque limiting tolerance ring 314 can fracture and move from the first configuration to the second configuration. In the second configuration, the first compressor shaft can rotate freely with respect to the second compressor shaft.

Accordingly, with the assembly disengaged, or decoupled, the drive belt can continue to move without a substantial increase in excessive heat or friction between the compressor pulley, the compressor shaft, and the drive belt that would likely occur if the compressor pulley remained statically engaged with the seized compressor shaft while the belt continued moving around the seized compressor pulley or it the belt continued to drive the compressor pulley around the shaft without the compressor pulley fully disengaged from the shaft. As such, the risk of damage to the drive belt, the compressor pulley, or other components driving the belt or being driven by the drive belt, can be substantially reduced. The compressor pulley can remain disengaged from the compressor shaft even if the motor vehicle is shut down and the drive belt stops moving. When the motor vehicle is subsequently started, there is little or no residual torque between the compressor shaft and the compressor pulley to be overcome by an engine drive shaft moving the drive belt.

In a particular aspect, a torque limiting tolerance ring according to any of the aspects described herein can be made from a metal, a metal alloy, or a combination thereof. The metal can include a ferrous metal. Further, the metal can include steel. The steel can include carbon steel. In another aspect, the steel can include stainless, such as austenitic stainless steel. Moreover, the steel can include stainless steel comprising chrome, nickel, or a combination thereof. For example, the steel can X10CrNi18-8 stainless steel. Further, the tolerance ring can include a Vickers pyramid number hardness, VPN, which can be ≧350, such as ≧375, ≧400, ≧425, or ≧450. VPN can also be ≦500, ≦475, or ≦450. VPN can also be within a range between, and including, any of the VPN values described herein. In another aspect, the tolerance ring can be treated to increase its corrosion resistance. In particular, the tolerance ring can be passivated. For example, the tolerance ring can be passivated according to the ASTM standard A967.

In another aspect, the stock material from which the tolerance ring can be formed can have a thickness, t, and t can be ≧0.05 mm, such as ≧0.1 mm, ≧0.2 mm, ≧0.3 mm, or ≧0.4 mm. In another aspect, t can be ≦1.0 mm, such as ≦0.75 mm, or ≦0.5 mm. Moreover, t can be within a range between, and including, any of the maximum and minimum values oft disclosed above.

For example, t can be ≧0.05 mm and ≦1.0 mm, such as ≧0.05 mm and ≦0.75 mm, or ≧0.05 mm and ≦0.5 mm. Further, t can be ≧0.1 mm and ≦1.0 mm, such as ≧0.1 mm and ≦0.75 mm, or ≧0.1 mm and ≦0.5 mm. In another aspect, t can be ≧0.2 mm and ≦1.0 mm, such as ≧0.2 mm and ≦0.75 mm, or ≧0.2 mm and ≦0.5 mm. Moreover, t can be ≧0.3 mm and ≦1.0 mm, such as ≧0.3 mm and ≦0.75 mm, or ≧0.3 mm and ≦0.5 mm. In addition, t can be ≧0.4 mm and ≦1.0 mm, such as ≧0.4 mm and ≦0.75 mm, or ≧0.4 mm and ≦0.5 mm.

The tolerance ring according to any of the aspects described herein may have an overall outer diameter, OD, and OD can be ≧5 mm, such as ≧10 mm, ≧20 mm, ≧30 mm, or ≧40 mm. The OD can be ≦100 mm, such as ≦90 mm, ≦80 mm, ≦70 mm, ≦60 mm, or ≦50 mm. OD can be within a range between and including any of the maximum and minimum values of OD described herein.

For example, OD can be ≧5 mm and ≦100 mm, such as ≧5 mm and ≦90 mm, ≧5 mm and ≦80 mm, ≧5 mm and ≦70 mm, ≧5 mm and ≦60 mm, or ≧5 mm and ≦50 mm. OD can be ≧10 mm and ≦100 mm, such as ≧10 mm and ≦90 mm, ≧10 mm and ≦80 mm, ≧10 mm and ≦70 mm, ≧10 mm and ≦60 mm, or ≧10 mm and ≦50 mm. OD can be ≧20 mm and ≦100 mm, such as ≧20 mm and ≦90 mm, ≧20 mm and ≦80 mm, ≧20 mm and ≦70 mm, ≧20 mm and ≦60 mm, or ≧20 mm and ≦50 mm. Further, OD can be ≧30 mm and ≦100 mm, such as ≧30 mm and ≦90 mm, ≧30 mm and ≦80 mm, ≧30 mm and ≦70 mm, ≧30 mm and ≦60 mm, or ≧30 mm and ≦50 mm. Additionally, OD can be ≧40 mm and ≦100 mm, such as ≧40 mm and ≦90 mm, ≧40 mm and ≦80 mm, ≧40 mm and ≦70 mm, ≧40 mm and ≦60 mm, or ≧40 mm and ≦50 mm.

In another aspect, the tolerance ring can have an overall axial length, L, and L can be ≧5 mm, such as ≧10 mm, or ≧15 mm. Additionally, L can be ≦50 mm, such as ≦40 mm, ≦30 mm, or ≦20 mm. Moreover, L can be within a range between and including any of the maximum and minimum values of L described above.

For example, L can be ≧5 mm and ≦50 mm, such as ≧5 mm and ≦40 mm, ≧5 mm and ≦30 mm, or ≧5 mm and ≦20 mm. Further, L can be ≧10 mm and ≦50 mm, such as ≧10 mm and ≦40 mm, ≧10 mm and ≦30 mm, or ≧5 mm and ≦20 mm. Still further, L can be ≧15 mm and ≦50 mm, such as ≧15 mm and ≦40 mm, ≧15 mm and ≦30 mm, or ≧15 mm and ≦20 mm.

In another aspect, each projection can have a radial height, H_{R}, and H_{R} can be ≧0.3 mm, such as ≧0.4 mm, ≧0.5 mm, ≧0.6 mm, or ≧0.7 mm. H_{R} can also be ≦2.0 mm, such as ≦1.5 mm, or ≦1 mm. H_{R} can also be within a range between and including any of the maximum and minimum vales of H_{R} described herein.

For example, H_{R} can be ≧0.3 mm and ≦2.0 mm, such as ≧0.3 mm and ≦1.5 mm, or ≧0.3 mm and ≦1 mm. Further, H_{R} can be ≧0.4 mm and ≦2.0 mm, such as ≧0.4 mm and ≦1.5 mm, or ≧0.4 mm and ≦1 mm. H_{R} can be ≧0.5 mm and ≦2.0 mm, such as ≧0.5 mm and ≦1.5 mm, or ≧0.5 mm and ≦1 mm. Moreover, H_{R} can be ≧0.6 mm and ≦2.0 mm, such as ≧0.6 mm and ≦1.5 mm, or ≧0.6 mm and ≦1 mm. In addition, H_{R} can be ≧0.7 mm and ≦2.0 mm, such as ≧0.7 mm and ≦1.5 mm, or ≧0.7 mm and ≦1 mm.

### EXAMPLE

A torque limiting tolerance ring is manufactured from carbon steel stock. The carbon steel stock has a thickness of 0.7 mm±0.013. The carbon steel stock is stamped to include a plurality of projections equally spaced along the stainless steel stock and arranged in rows. Additionally, a frangible portion is formed in the stainless steel stock in a row between adjacent rows of the plurality of projections. Each projection has a height of 1.13 mm. The stainless steel stock is rolled into cylinder to form a torque limiting tolerance ring adapted to fit onto a shaft having a diameter of 20 mm. The formed torque limiting tolerance ring includes a plurality of elongated projections equally spaced around the circumference of the torque limiting tolerance ring and extending along an axial length of the torque limiting tolerance ring. Each projection has a radial height of 1.13 mm. Moreover, the torque limiting tolerance ring has an axial length of 15.8 mm.

The torque limiting tolerance ring is installed on two colinear shafts. A first outer collar is installed around the torque limiting tolerance ring so that a first row of projections engage an inner wall of the first outer collar and are compressed between the outer collar and an end of one of the shafts. A second outer collar is also installed around the torque limiting tolerance ring so that a second row of projections engage an inner wall of the second outer collar and are compressed between the outer collar and an end of the other of the shafts. A drive motor is coupled to one of the shafts and a brake is applied to the other of the shafts. The shafts are rotated and a braking force is applied and gradually increased. When the braking force reaches a critical value, and a torque overload condition occurs, a torque between the first and second shaft reaches a threshold value that causes the frangible portion of the torque limiting tolerance ring to fracture. After the frangible portion is completely fractured, the first shaft can be decoupled from the second shaft and the shafts can rotate freely with respect to each other.

Item 1. A torque limiting tolerance ring, comprising:
a generally cylindrical body having a sidewall, wherein the sidewall includes:
an unformed section;
a plurality of projections extending from the unformed section of the sidewall, wherein the plurality of projections are arranged in a first circumferential row and a second circumferential row; and
a frangible portion extending circumferentially around the tolerance ring between the first and second rows of projections.

Item 2. An assembly, comprising:
a first component;
a second component collinear to the first inner component;
a slip interface between the first and second components; and
a torque limiting tolerance ring engaged with the first component and the second component and spanning the slip interface, wherein the torque limiting tolerance ring includes:
a generally cylindrical body having a sidewall, wherein the sidewall includes:
an unformed section;
a plurality of projections extending from the unformed section of the sidewall; and
a frangible portion extending circumferentially around the body of the torque limiting tolerance ring at or near the slip interface between the first and second inner components.

Item 3. An assembly, comprising:
a first shaft;
a second shaft aligned with the first shaft along an axis of rotation;
a slip interface between the first and second shafts;
a first collar circumscribing an end of the first shaft;
a second collar circumscribing an end of the second shaft;
a torque limiting tolerance ring installed around the end of the first shaft between the first shaft and the first collar and around the end of the second shaft between the second shaft and the second collar and spanning the slip interface between the first and second shafts, wherein the torque limiting tolerance ring includes:
a generally cylindrical body having a sidewall, wherein the sidewall includes:
an unformed section;
a plurality of projections extending from the unformed section of the sidewall; and
a frangible portion extending circumferentially around the body of the torque limiting tolerance ring, wherein the torque limiting tolerance ring is movable from a first configuration in which the frangible portion is intact and the first shaft is coupled to the second shaft and rotates therewith and a second configuration in which the frangible portion is fractured and the first and second shafts are decoupled and rotated freely with respect to each other.

Item 4. The torque limiting tolerance ring or the assembly according to any of items 1, 2, or 3, wherein the body of the torque limiting tolerance ring comprises a torsional strength, T_{SP}, measured circumferentially through the frangible portion and a torsional strength, T_{SP}, measured circumferentially through the projections and T_{SFP}≦T_{SP}.

Item 5. The torque limiting tolerance ring or the assembly according to item 4, wherein T_{SF}≦50% T_{SP}, such as ≦45% T_{SP}, ≦40% T_{SP}, or ≦35% T_{SP}.

Item 6. The torque limiting tolerance ring or the assembly according to item 5, wherein T_{SF}≧1% T_{SP}, such as ≧5% T_{SP}, ≧10% T_{SP}, or ≧20% T_{SP}.

Item 7. The torque limiting tolerance ring or the assembly according to any of items 1, 2, or 3, wherein the frangible portion comprises a plurality of perforations around the circumference of the frangible portion, wherein each adjacent pair of perforations is separated by a frangible sidewall.

Item 8. The torque limiting tolerance ring or the assembly according to item 7, wherein the perforations are equally spaced around the circumference of the frangible portion.

Item 9. The torque limiting tolerance ring or the assembly according to item 8, wherein each perforation is substantially identical.

Item 10. The torque limiting tolerance ring or the assembly according to item 9, wherein each perforation includes a circumferential length, L_{P}, and each frangible sidewall includes a circumferential length, L_{FS}, and L_{P}≦1000% L_{FS}, such as ≦750% L_{FS}, ≦500% L_{FS}, ≦250% L_{FS}, or ≦100% L_{FS}.

Item 11. The torque limiting tolerance ring or the assembly according to item 10, wherein L_{P}≧10% L_{FS}, such as ≧15% L_{FS}, ≧20% L_{FS}, or ≧25% L_{FS}.

Item 12. The torque limiting tolerance ring or the assembly according to item 9, wherein each perforation is generally circular.

Item 13. The torque limiting tolerance ring or the assembly according to item 9, wherein each perforation is generally oval.

Item 14. The torque limiting tolerance ring or the assembly according to item 9, wherein each perforation is generally slot shaped.

Item 15. The torque limiting tolerance ring or the assembly according to item 9, wherein each perforation is generally rectangular.

Item 16. The torque limiting tolerance ring or the assembly according to item 9, wherein each perforation is generally diamond shaped.

Item 17. The torque limiting tolerance ring or the assembly according to item 9, wherein each perforation is generally triangular.

Item 18. The torque limiting tolerance ring or the assembly according to any of items 1, 2, or 3, wherein the frangible portion comprises a frangible sidewall, the frangible sidewall includes a wall thickness, T_{FS}, the unformed portion of the sidewall includes a wall thickness, T_{UP}, and T_{FS}<T_{UP}.

Item 19. The torque limiting tolerance ring or the assembly according to item 18, wherein T_{FS}≦75% T_{UP}, such as ≦70% T_{UP}, ≦65% T_{UP}, or ≦60% T_{UP}.

Item 20. The torque limiting tolerance ring or the assembly according to item 19, wherein T_{FS}≧5% T_{UP}, such as ≧10% T_{UP}, ≧15% T_{UP}, or ≧20% T_{UP}.

Item 21. The torque limiting tolerance ring or the assembly according to any of items 1, 2, or 3, wherein the frangible portion comprises a frangible sidewall, the frangible sidewall includes a brittleness, B_{FS}, the unformed portion of the sidewall includes a brittleness, B_{UP}, and B_{UP}<B_{FS}.

Item 22. The torque limiting tolerance ring or the assembly according to item 21, wherein B_{UP}≦75% B_{FS}, such as ≦70% B_{FS}, ≦65% B_{FS}, or ≦60% B_{FS}.

Item 23. The torque limiting tolerance ring or the assembly according to item 22, wherein B_{UP}≧5% B_{FS}, such as ≧10% B_{FS}, ≧15% B_{FS}, or ≧20% B_{FS}.

Item 24. The torque limiting tolerance ring or the assembly according to item 21, wherein the frangible sidewall is treated to increase B_{FS}.

Item 25. The torque limiting tolerance ring or the assembly according to item 24, wherein the frangible sidewall is mechanically treated.

Item 26. The torque limiting tolerance ring or the assembly according to item 25, wherein the frangible sidewall is drawn or stretched.

Item 27. The torque limiting tolerance ring or the assembly according to item 26, wherein the frangible sidewall is locally heated and quenched.

Item 28. The torque limiting tolerance ring or the assembly according to item 24, wherein the frangible sidewall is chemically treated

Item 29. The torque limiting tolerance ring or the assembly according to item 28, wherein the frangible sidewall is etched.

Item 30. The torque limiting tolerance ring or the assembly according to any of items 1, 2, or 3, wherein the frangible portion fractures if an operating torque, T_{O}, exceeds a threshold torque, T_{T}.

Item 31. The torque limiting tolerance ring or the assembly according to item 30, wherein the torque limiting tolerance ring comprises a slip torque, T_{S}, above which the projections can move relative to an inner wall of a bore and T_{T}≦90% T_{S}, such as ≦85% T_{S}, or ≦80% T_{S}.

Item 32. The torque limiting tolerance ring or the assembly according to item 31, wherein T_{S}≧20% T_{T}, such as ≧25% T_{T}, or ≧30% T_{T}.

Item 33. A torque limiting tolerance ring adapted to be installed around a first component and a second component collinear to the first component, wherein the torque limiting tolerance ring is adapted to rupture along a plane formed between the first and second components prior to reaching a slip torque condition.

Item 34. A torque limiting tolerance ring adapted to be installed around a first component having an applied driving torque, T1, and a second component collinear to the first component, the second component having an applied resistive torque, T2, applied opposite T2, wherein the torque limiting tolerance ring is adapted to rupture when a ratio of |T2|:|T1| is at least about 0.9.

Item 35. A torque limiting tolerance ring adapted to be installed around a first component and a second component collinear to the first component, one of the first and second components engaged with a drive mechanism, wherein the torque limiting tolerance ring is adapted to rupture prior to damaging the first or second components or the drive mechanism.

A skilled artisan can recognize that there may be others applications that can utilize a torque limiting tolerance ring having one or more of the characteristics described herein. Further, it can be appreciated that while only two rows of projections are shown, the torque limiting tolerance ring can include three rows, four rows, etc. Further, the projections can have different sizes or shapes to accommodate for variations in stiffness caused by proximity to the gap. For example, the projections can have varying circumferential widths, varying radial heights, varying axial lengths, etc. Moreover, the shape of the perforations in the frangible portion of the torque limiting tolerance ring can vary in size or shape to account for the weakness in the torque limiting tolerance ring caused by the gap to ensure an even break when a threshold torque is reached.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

In addition, in the foregoing Detailed Description, various features can be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter can be directed to less than all features of any of the disclosed embodiments. Thus, the following claims are incorporated into the Detailed Description, with each claim standing on its own as defining separately claimed subject matter.

What is claimed is:

1. A torque limiting tolerance ring, comprising:
a generally cylindrical body having a sidewall, wherein the sidewall includes:
an unformed section;
a plurality of projections extending from the unformed section of the sidewall, wherein the plurality of projections are arranged in a first circumferential row and a second circumferential row; and
a frangible portion extending circumferentially around the tolerance ring between the first and second rows of projections.

2. The torque limiting tolerance ring according to claim 1, wherein the body of the torque limiting tolerance ring comprises a torsional strength, T_{SP}, measured circumferentially through the frangible portion and a torsional strength, T_{SP}, measured circumferentially through the projections and T_{SF}<T_{SP}.

3. The torque limiting tolerance ring according to claim 1, wherein the frangible portion comprises a plurality of perforations around the circumference of the frangible portion, wherein each adjacent pair of perforations is separated by a frangible sidewall.

4. The torque limiting tolerance ring according to claim 3, wherein the perforations are equally spaced around the circumference of the frangible portion.

5. The torque limiting tolerance ring according to claim 4, wherein each perforation is substantially identical.

6. The torque limiting tolerance ring according to claim 5, wherein each perforation includes a circumferential length, L_{P}, and each frangible sidewall includes a circumferential length, L_{FS}, and L_{P}≦1000% L_{FS}.

7. The torque limiting tolerance ring according to claim 6, wherein L_{P}≧10% L_{FS}.

8. The torque limiting tolerance ring according to claim 3, wherein each perforation is generally ovular.

9. The torque limiting tolerance ring according to claim 3, wherein each perforation is generally polygonal.

10. The torque limiting tolerance ring according to claim 3, wherein each perforation is generally diamond shaped.

11. The torque limiting tolerance ring according to claim 1, wherein the frangible portion comprises a frangible sidewall, the frangible sidewall includes a wall thickness, T_{FS}, the unformed portion of the sidewall includes a wall thickness, T_{UP}, and T_{FS}<T.

12. The torque limiting tolerance ring according to claim 1, wherein the frangible portion comprises a frangible sidewall, the frangible sidewall includes a brittleness, B_{FS}, the unformed portion of the sidewall includes a brittleness, B_{UP}, and B_{UP}<B_{FS}.

13. The torque limiting tolerance ring according to claim 12, wherein the frangible sidewall is treated to increase B_{FS}.

14. The torque limiting tolerance ring according to claim 13, wherein the frangible sidewall is mechanically treated.

15. The torque limiting tolerance ring according to claim 13, wherein the frangible sidewall is chemically treated

16. The torque limiting tolerance ring according to claim 1, wherein the frangible portion is adapted to fracture if an operating torque, T_{O}, exceeds a threshold torque, T_{T}.

17. The torque limiting tolerance ring according to claim 16, wherein the torque limiting tolerance ring comprises a slip torque, Tₛ, above which the projections can move relative to an inner wall of a bore and T_{T}<90% T_{S}.

18. The torque limiting tolerance ring according to claim 17, wherein T≧20% T_{T}.

19. An assembly, comprising:
a first component;
a second component collinear to the first inner component;
a slip interface between the first and second components; and
a torque limiting tolerance ring engaged with the first component and the second component and spanning the slip interface, wherein the torque limiting tolerance ring includes:
a generally cylindrical body having a sidewall, wherein the sidewall includes:
an unformed section;
a plurality of projections extending from the unformed section of the sidewall; and
a frangible portion extending circumferentially around the body of the torque limiting tolerance ring at or near the slip interface between the first and second inner components.

20. A torque limiting tolerance ring adapted to be installed around a first component and a second component collinear to the first component, wherein the torque limiting tolerance ring is adapted to rupture along a plane formed between the first and second components prior to reaching a slip torque condition.
